(19) United States
(12) Patent Application Publication
(10) Pub. No.: US 2010/0172409 A1
(43) Pub. Date: Jul. 8, 2010

(54) LOW-COMPLEXITY TRANSFORMS FOR DATA COMPRESSION AND DECOMPRESSION

(75) Inventors: Yuriy Reznik, San Diego, CA (US); Ravi Kiran Chivukula, San Diego, CA (US); John H. Hong, San Clemente, CA (US); Chong U. Lee, San Diego, CA (US)

Correspondence Address: QUALCOMM INCORPORATED, 5775 MOREHOUSE DR., SAN DIEGO, CA, 92121, US

(73) Assignee: QUALCOM Incorporated, San Diego, CA (US)

(21) Appl. No.: 12/349,406

(22) Filed: Jan. 6, 2009

(51) Int. Cl. H04N 7/30; G06K 9/46

(52) U.S. Cl. 375/240.2; 382/250; 375/E07.226

(57) ABSTRACT

This disclosure describes the use of non-dyadic discrete cosine transform (DCT) sizes for performing a DCT. Similarly, this disclosure describes the use of non-dyadic inverse discrete cosine transform (IDCT) sizes for performing an IDCT. Using non-dyadic transform sizes may be less computationally expensive compared to using conventional dyadic transform sizes. Aspects of this disclosure may be useful in any device or system that performs a DCT or IDCT.

### TECHNICAL FIELD

This disclosure relates to transforms in image and video applications and, more particularly, to discrete cosine transforms (DCTs).

### BACKGROUND

Data compression is widely used in a variety of applications to reduce consumption of data storage space, transmission bandwidth, or both. Example applications of data compression include digital video coding, image coding, speech coding, and audio coding. Digital video coding, for example, is used in wide range of devices, including digital televisions, digital direct broadcast systems, wireless communication devices, personal digital assistants (PDAs), laptop or desktop computers, digital cameras, digital recording devices, video gaming devices, cellular or satellite radio telephones, or the like. Digital video devices implement video compression techniques, such as MPEG-2, MPEG-4, or H.264/MPEG-4 Advanced Video Coding (AVC), to transmit and receive digital video more efficiently.

In general, video compression techniques perform predictive coding, such as intra-coding and/or inter-coding to reduce or remove redundancy inherent in video data. Intra-coding relies on spatial prediction to reduce or remove spatial redundancy in video within a given video frame. Inter-coding relies on temporal prediction to reduce or remove temporal redundancy in video within adjacent frames. For inter-coding, a video encoder performs motion estimation to track the movement of matching video blocks between two or more adjacent frames. Motion estimation generates motion vectors, which indicate the displacement of video blocks relative to corresponding video blocks in one or more reference frames. Motion compensation uses the motion vector to generate a prediction video block from a reference frame. After motion compensation, a residual video block is formed by subtracting the prediction video block from the original video block.

For intra-coding, a video encoder may perform spatial estimation to track continuations or replications of certain textures or patterns within the same frame. Spatial estimation generates prediction syntax, which indicates the manner in which a predictive block is generated based on, e.g., adjacent pixels within the same frame. The process of generating the predictive block during intra-coding is often called intra-prediction. After intra-prediction, a residual image is formed by subtracting the prediction block from the original block to be coded.

Following predictive coding, video encoder applies a discrete cosine transform (DCT), quantization, and entropy coding processes to further reduce the bit rate of the residual block produced by the video coding process. The DCT process is a transform process that converts a set of pixel values into transform coefficients, which represent the energy of the pixel values in the frequency domain. Quantization is then applied to the transform coefficients, and generally involves a process that limits the number of bits associated with any given transform coefficient. Entropy coding comprises one or more processes that collectively compress a sequence of quantized transform coefficients. Entropy encoding generally involves the application of arithmetic codes or variable length codes (VLCs) to further compress residual coefficients produced by the transform and quantization operations. Examples of entropy coding techniques include context-adaptive binary arithmetic coding (CABAC) and context-adaptive variable length coding (CAVLC), which may be used as alternative entropy coding modes in some encoders. A video decoder performs entropy decoding to decompress residual information for each of the blocks, and reconstructs the encoded video using the prediction syntax and the residual information.

### SUMMARY

In general, this disclosure describes the use of particular (non-dyadic) discrete cosine transform (DCT) sizes for performing a DCT in an encoder for image and video compression. This disclosure also describes the use of particular (non-dyadic) inverse discrete cosine transform (IDCT) sizes when performing an IDCT in a decoder for image and video decompression. In this disclosure, DCT refers to any variant of a DCT. For example, there include at least four variations of DCTs referred to as DCT-I, DCT-II, DCT-III, and DCT-IV transforms. Such transforms can work with distinct, non-overlapped blocks of pixels, or may be executed over partially overlapped blocks, therefore forming lapped variants of DCT. In this disclosure, DCT is defined to encompass any variation of DCT. Similarly, IDCT refers to any variant of an IDCT such as IDCT-I, IDCT-II, IDCT-III, or IDCT-IV transforms, executed over separated blocks or possibly executed with respect to overlapped blocks of data.

In one example, this disclosure describes an apparatus comprising a discrete cosine transform (DCT) unit that receives digital image data and generates DCT coefficients. The DCT unit applies a transform size of at least one of 6, 10, 11, 12, 13, 14, and 15.

In another example, this disclosure describes a method comprising receiving digital image data in a discrete cosine transform (DCT) unit and generating DCT coefficients via the DCT unit. The DCT unit applies a transform size of at least one of 6, 10, 11, 12, 13, 14, and 15.

In another example, this disclosure describes a computer readable storage medium comprising instructions that upon execution cause one or more processors to receive digital image data and generate discrete cosine transform (DCT) coefficients. The instructions cause the one or more processors to apply a transform size of at least one of 6, 10, 11, 12, 13, 14, and 15 to generate the DCT coefficients.

In another example, this disclosure describes an apparatus comprising means for receiving digital image data, and means for generating discrete cosine transform (DCT) coefficients. The means for generating DCT coefficients applies a transform size of at least one of 6, 10, 11, 12, 13, 14, and 15.

In another example, this disclosure describes a device comprising a discrete cosine transform (DCT) unit that receives digital image data and generates DCT coefficients. The DCT unit applies a transform size of at least one of 6, 10, 11, 12, 13, 14, and 15. The device further comprises a wireless transmitter that transmits an encoded bitstream that includes the DCT coefficients.

In another example, this disclosure describes a device comprising a wireless receiver that receives an encoded bitstream comprising an encoded unit of video data including a plurality of video blocks, discrete cosine transform (DCT) coefficients, and prediction syntax, an entropy decoding unit that receives the encoded bitstream from the wireless receiver and decodes the bitstream to generate the plurality of video blocks, the DCT coefficients, and the prediction syntax, and an inverse quantization unit that performs inverse quantization on the DCT coefficients. The device further comprises an inverse discrete cosine transform (IDCT) unit that performs an inverse DCT on the inverse quantized DCT coefficients by employing a transform size of at least one of 6, 10, 11, 12, 13, 14, and 15 to generate a residual block, and a prediction unit that receives the prediction syntax and generates a prediction block. The device further comprises a summer that sums the residual block and the prediction block to generate a reconstructed block, and a storage unit that stores the reconstructed block.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating a system for video encoding and decoding that may implement one or more DCT techniques of this disclosure.

FIG. 2 is a block diagram illustrating a system for video filtering that may implement one or more DCT techniques of this disclosure.

FIG. 3 is a block diagram illustrating an example of a video encoder, which may correspond to the video encoder shown in FIG. 1.

FIG. 4 is a block diagram illustrating an example of a video decoder, which may correspond to the video decoder as shown in FIG. 1.

FIG. 5 is a graph illustrating a weighted complexity normalized by a transform size as a function of transform size.

FIG. 6 is an example graph illustrating approximate peak signal to noise ratio (PSNR) values generated for various DCT transform sizes as a function of bit rate for an image with resolution of 384×256.

FIG. 7 is an example graph illustrating approximate PSNR values generated for various DCT transform sizes as a function of bit rate for an image with resolution of 3072×2048.

FIG. 8 is a conceptual circuit flow diagram illustrating an exemplary DCT with a transform size of 15 that can be used to realize a two dimensional (2D) transform for a block of data that has a 15×15 pixel block size.

FIG. 9 is a flow diagram illustrating an example technique of dividing a transform size into a plurality of sub-transform sizes.

FIG. 10 is a flow diagram illustrating an example technique of filtering digital image data that uses the video filtering system of FIG. 2.

FIG. 11 is a flow diagram illustrating an example technique of encoding digital image data making use of transforms applied to a block of data that has a non-dyadic pixel block size.

FIG. 12 is a flow diagram illustrating an example technique of decoding digital image data making use of transforms applied to an encoded video bitstream.

### DETAILED DESCRIPTION

This disclosure describes the use of non-dyadic discrete cosine transform (DCT) sizes to perform a DCT. Similarly, this disclosure describes the use of non-dyadic inverse discrete cosine transform (IDCT) sizes to perform an IDCT. A DCT expresses a vector of data points in terms of a sum of weighted vectors of cosine functions oscillating at different frequencies. Similarly, a two-dimensional (2D) DCT expresses a matrix of data points in terms of a sum of weighted matrices of cosine functions oscillating at different frequencies. In image and video coding, the matrix of many data points may correspond to pixels within blocks of the video sequence. In this case, DCT generates a frequency domain representation of pixel values within a block in a video sequence. The output values following a DCT are referred to as DCT coefficients, which may be viewed as the weights of each cosine function. Inversely, an IDCT may receive DCT coefficients and generate a pixel domain representation of the block in the video sequence.

Conventional encoders are limited to dyadic sized blocks of data when performing a DCT in an encoder. To perform the DCT, a DCT unit employs a transform size that is the same as the size of the blocks of data. As used herein, when referring to a size of a transform, it should be noted that the size of the transform refers to the size of the block of data that is to be transformed. However, for ease of description, the terms “transform size,” “DCT of size,” and like will be used. For example, DCT of size 8 has served as the transform of choice in H.261, JPEG, MPEG-1, MPEG-2, H.263, and MPEG-4 (P.2). Consequently H.261, JPEG, MPEG-1, MPEG-2, H.263, and MPEG-4 (P.2) employ data block sizes of 8×8. More recent standards, such as MPEG-4 AVC/H.264, VC-1, and AVS have adopted integer approximations of DCT with transform sizes: 4, 8, and 16. Consequently MPEG-4 AVC/H.264, VC-1, and AVS employ data block sizes of 4×4, 8×8, and 16×16 (VC-1 additionally uses rectangular sizes, such as 4×8, 8×4, etc). An emerging JPEG-XR image compression algorithm uses overlapping transforms, which are also based on a DCT of size 4.

It should also be noted, that the term dyadic as used herein refers to an integer that can be factored to its lowest level employing only multiples of two. Stated another way, the logarithm with base two of a dyadic number is an integer. All other numbers are referred to as non-dyadic. Examples of dyadic numbers are 2, 4, 8, 16, 32, 64, and so on. Examples of non-dyadic numbers are 3, 5, 6, 7, 9, 10, and so on.

DCT sizes need not be limited to dyadic DCT sizes, i.e., DCT with respect to a block of data that defines a non-dyadic block size, nor do they need to be limited to even number sizes. For example, DCT sizes of 3, 5, 6, 9, and 15 may be used. Stated another way, a block of data may comprise a non-dyadic size of 3, 5, 6, 9, and 15, and may be transformed using a non-dyadic transform size. In some aspects, using a non-dyadic DCT size for a DCT may provide computational or power savings compared to using a dyadic DCT size for a DCT. In some instances, using non-dyadic DCT sizes may provide twice as much power saving compared to using dyadic DCT sizes.

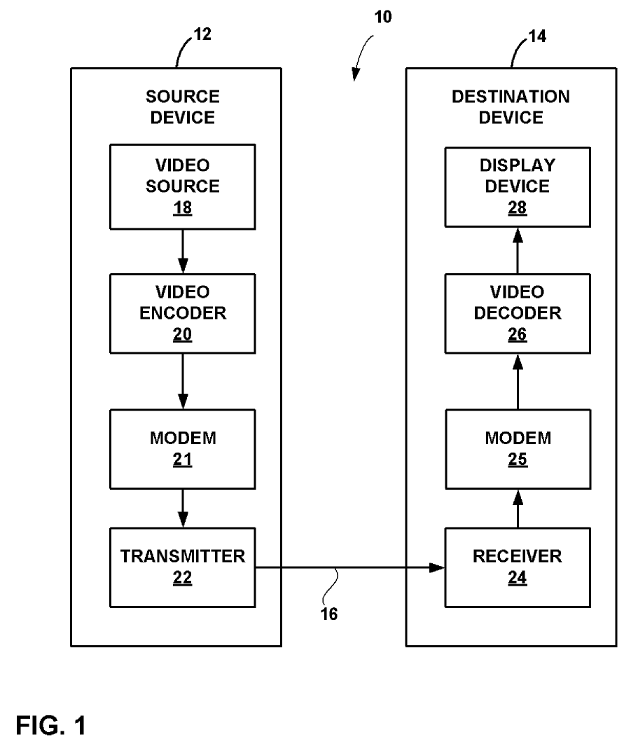

FIG. 1 is a block diagram illustrating a system 10 for video encoding and decoding that may implement one or more of the DCT techniques of this disclosure. As shown in FIG. 1, system 10 includes a source device 12 that transmits encoded video to a destination device 14 via a communication channel 16. In some aspects, source device 12 may be referred to as a wireless communication device handset for processing digital image data. Source device 12 may include a video source 18, video encoder 20, a modulator/demodulator (modem) 21, and a transmitter 22. Destination device 14 may also be referred to as a wireless communication device handset for processing digital image data. Destination device 14 may include a receiver 24, a modem 25, video decoder 26 and video display device 28. Some examples of source device 12 and destination device 14 include mobile telephones, personal digital assistant (PDA), portable video players, video gaming consoles, and the like.

System 10 may be configured to apply techniques for low complexity discrete cosine transform (DCT) and inverse discrete cosine transform (IDCT) of digital image data. In particular, the low complexity DCT techniques may be used for transforming residual block coefficients produced by a predictive video coding process on a non-dyadic block sizes. For example, system 10 may employ a DCT that uses a non-dyadic transform size.

In the example of FIG. 1, communication channel 16 may comprise any wireless or wired communication medium, such as a radio frequency (RF) spectrum or one or more physical transmission lines, or any combination of wireless and wired media. Channel 16 may form part of a packet-based network, such as a local area network, wide-area network, or a global network such as the Internet. Communication channel 16 generally represents any suitable communication medium, or collection of different communication media, for transmitting video data from source device 12 to destination device 14. The techniques of this disclosure, however, which apply more generally to DCTs, are not limited to wireless applications or settings, any may be applied to any device that includes video encoding and/or decoding capabilities. For example, some techniques of this disclosure may be applied by digital cameras.

Source device 12 generates video for transmission to destination device 14. In some cases, however, devices 12, 14 may operate in a substantially symmetrical manner. For example, each of devices 12, 14 may include video encoding and decoding components. Hence, system 10 may support one-way or two-way video transmission between video devices 12, 14, e.g., for video streaming, video broadcasting, or video telephony. For other data compression and coding applications, devices 12, 14 could be configured to send and receive, or exchange, other types of data, such as image, speech or audio data, or combinations of two or more of video, image, speech and audio data. Accordingly, discussion of video applications is provided for purposes of illustration and should not be considered limiting of the various aspects of the disclosure as broadly described herein.

Video source 18 may include a video capture device, such as one or more video cameras, a video archive containing previously captured video, or a live video feed from a video content provider. As a further alternative, video source 18 may generate computer graphics-based data as the source video, or a combination of live video and computer-generated video. In some cases, if video source 18 is a camera, source device 12 and destination device 14 may form so-called camera phones or video phones. In each case, the captured, pre-captured or computer-generated video may be encoded by video encoder 20 in techniques described in more detail below.

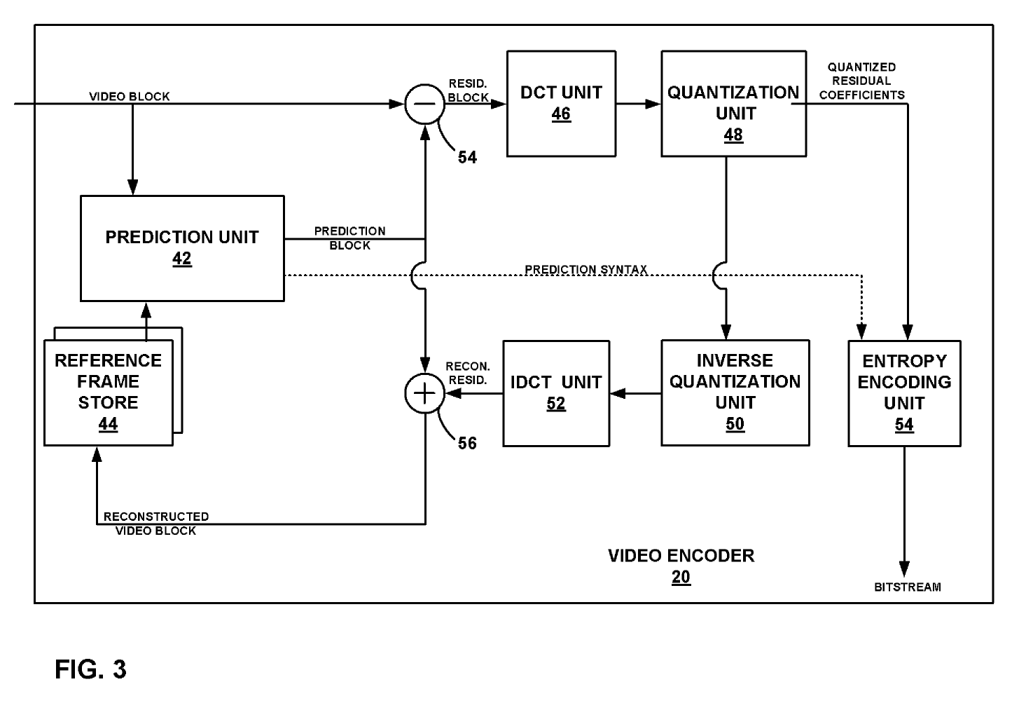

Video encoder 20 operates on blocks of pixels within individual video frames in order to encode the video data. The video blocks may have fixed or varying sizes, and may differ in size according to design considerations such as memory availability. Each video frame includes a series of slices. Each slice may include a series of macroblocks, which may be arranged into blocks. The blocks are blocks of pixels of the video frame. In accordance with the disclosure, the size of the blocks, i.e. blocks of pixels, may be non-dyadic, e.g. the size of the block is 15×15 or 6×6. Video encoder 20 performs a DCT of the blocks via DCT unit to generate DCT coefficients as described in more detail below with respect to FIG. 3. The data received by the DCT unit may be referred to a digital image data. The digital image data may be the data provided by video source 18, or may be data processed by various components within video encoder 20 as described in more detail with respect to FIG. 3. In some aspects, the size of the DCT may be the same as the size of the block. In some other aspects, the size of the DCT may be a multiple of the size of the block. For example a block with size 15×15 may be divided to nine sub-blocks of size 5×5 and the sub-transform size for each sub-block may be 5×5. As used herein, the term sub-transform size refers to the transform size of a sub-block. As another example, a block with size 15×15 may be divided to twenty-five sub-blocks of size 3×3. The size of the DCT may be any multiple of the size of the block, and is not limited to equal sized blocks. For example, a block with size 15×15 may be divided to fifteen sub-blocks of size 3×5 or 5×3. Other multiplies of the block size are also contemplated by this disclosure. For example, a block with size 15×15 may be divided to five sub-blocks of size 3×15 or 15×3. As yet another example, a bock with size 15×15 may be divided to three sub-blocks of size 5×15 or 15×5. The block with size 15×15 is provided merely for illustrative purposes, and should not be considered as limiting. For example, a block with size 6×6 may be divided to six sub-block of size 2×3 or 3×2, or six sub-blocks of 6×1 or 1×6. Various permutations of dividing a certain block size into sub-blocks may be possible, and are contemplated by this disclosure.

Once the video data is encoded by video encoder 20, the encoded video information may then be modulated by modem 21 according to a communication standard, e.g., such as code division multiple access (CDMA) or another communication standard or technique, and transmitted to destination device 14 via transmitter 22. Modem 21 may include various mixers, filters, amplifiers or other components designed for signal modulation. Transmitter 22 may include circuits designed for transmitting data, including amplifiers, filters, and one or more antennas.

Receiver 24 of destination device 14 receives information over channel 16, and modem 25 demodulates the information. Video decoder 26 operates on the encoded blocks to decompress the encoded video sequence. Similar to video encoder 20, video decoder 26 may employ a non-dyadic IDCT transform size. In some aspects, video decoder 26 may employ the same transform size as video encoder 20. Display device 28 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 26 may be configured to support scalable video coding for spatial, temporal and/or signal-to-noise ratio (SNR) scalability. In some aspects, video encoder 20 and video decoder 22 may be configured to support fine granularity SNR scalability (FGS) coding for SVC. Encoder 20 and decoder 26 may support various degrees of scalability by supporting encoding, transmission and decoding of a base layer and one or more scalable enhancement layers. For scalable video coding, a base layer carries video data with a minimum level of quality. One or more enhancement layers carry additional bitstream to support higher spatial, temporal and/or SNR levels.

Although not shown in FIG. 1, in some aspects, video encoder 20 and video decoder 26 may be integrated with an audio encoder and decoder, respectively, and include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

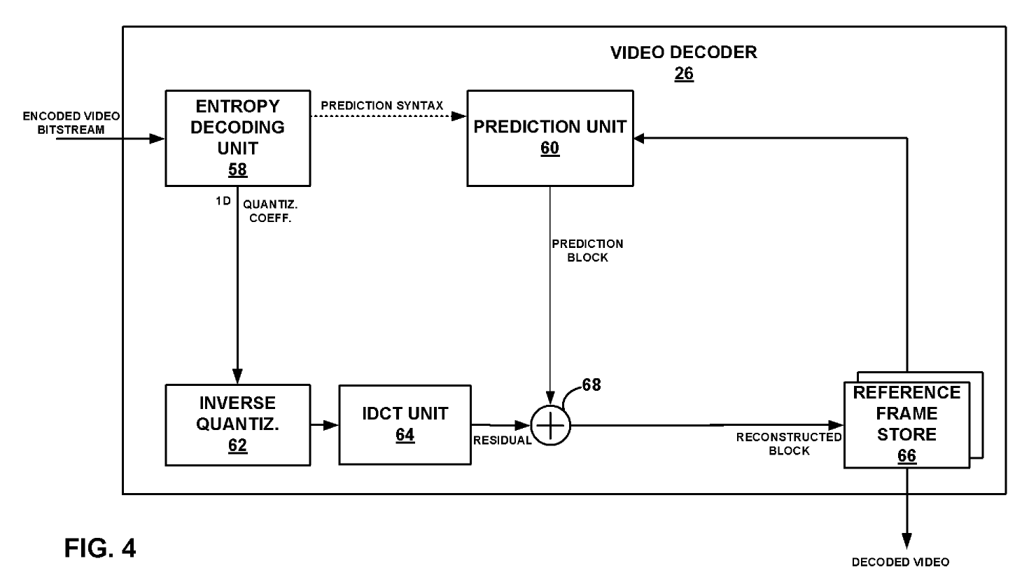

Video encoder 20 and video decoder 26 each may be implemented as one or more microprocessors, digital signal processors (DSPs), application specific integrated circuits (ASICs), field programmable gate arrays (FPGAs), discrete logic, software, hardware, firmware or any combinations thereof. In some aspects, system 10 may include one or more computer readable storage mediums that comprise instructions that upon execution cause the one or more processors to perform various functions described with respect to FIGS. 3 and 4. Examples of a computer readable storage medium include volatile memory such as FLASH memory or various forms of random access memory (RAM) including dynamic random access memory (DRAM), synchronous dynamic random access memory (SDRAM), static random access memory (SRAM), and the like.

Video encoder 20 and/or video decoder 26 of system 10 of FIG. 1 may be configured to quantize the DCT coefficients generated by a DCT and entropy code the quantized DCT coefficients to further reduce the bit rate of the residual block produced by the video coding process. Entropy encoding techniques are used in the final stages of a video encoder-decoder (CODEC), and in various other coding applications, prior to storage or transmission of the encoded data. Entropy encoding generally involves the application of arithmetic codes or variable length codes (VLCs) to further compress residual coefficients produced by the transform and quantization operations. Examples of entropy coding techniques include context-adaptive binary arithmetic coding (CABAC) and context-adaptive variable length coding (CAVLC), which may be used as alternative entropy coding modes in some encoders. However any type of entropy coding techniques may be used. Additionally, the coding techniques are not limited to entropy coding, any coding technique may be used. Entropy coding techniques are disclosed for illustrative purposes only. A video decoder performs entropy decoding to decompress residual information for each of the blocks, and reconstructs the encoded video using motion information and the residual information.

Although FIG. 1 describes a video encoding and decoding system, aspects of the disclosure are not so limited. As one example, the DCT techniques of the disclosure may be used in different systems, such as image encoding and decoding systems, or image filtering systems. Generally, any system or device that employs DCT techniques may benefit from aspects of the disclosure.

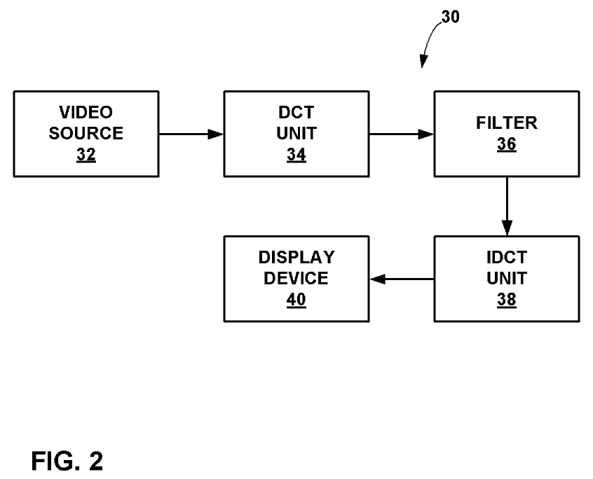

FIG. 2 is a block diagram illustrating a system 30 for video filtering that may implement one or more of the DCT techniques of this disclosure. Video filtering system 30 may be used filter image data and maybe useful in digital cameras and like. System 10 (FIG. 1) describes video encoding and decoding. System 30 (FIG. 2) describes a filtering system to filter unwanted artifacts in a digital video sequence or in an image. Video filtering system 30 includes video source 32, DCT unit 34, filter 36, IDCT unit 38, and display device 40. Although shown as separate modules, DCT unit 34, filter 36, and IDCT unit 38 may be implemented as one or more microprocessors, DSPs, ASICs, FPGAs, discrete logic, software, hardware, firmware or any combinations thereof. Alternatively, DCT unit 34, filter 36, and IDCT unit 38 may be implemented in separate microprocessors, DSPs, ASICs, FPGAs, discrete logic, software, hardware, firmware or any combinations thereof. System 30 may also include a computer readable storage medium (not shown) that includes instructions that upon execution cause the one or more processors to perform their various functions as described below. Examples of computer readable storage medium include volatile memory such as FLASH memory or various forms of random access memory (RAM) including dynamic random access memory (DRAM), synchronous dynamic random access memory (SDRAM), static random access memory (SRAM), and the like.

Video source 32 may be substantially similar to video source 18 (FIG. 1). DCT unit 34 receives digital image data, i.e. a video sequence, from video source 32 and performs discrete cosine transforms on the digital image data of video source 32. For example, DCT unit 34 performs DCTs on the blocks of the video frames. In the example of FIG. 2, DCT unit 34 may employ non-dyadic transform sizes, e.g. a transform size of 10×10 or 15×15, to perform the DCTs and generate DCT coefficients. In some aspects, DCT unit 34 may further divide the transform size. For example, DCT unit 34 may divide a 15×15 transform size to nine 5×5 sub-transform sizes, twenty-five 3×3 sub-transform sizes, fifteen 3×5 or 5×3 sub-transform sizes, five 3×15 or 15×3 transform sizes, three 5×15 or 15×5 transform sizes, and the like. To perform a transform of 15×15, DCT unit 34 may divide the transform size of 15×15 to a sub-transform sizes of 5×5, 3×3, or any multiple of 15×15 based on the quality of the video or image data generated by video source 32. For example if blocks that are to be transformed include sharp edges or are highly detailed images and the size of the blocks is 15×15, DCT unit 34 may divide the blocks into nine sub-blocks each comprising a sub-block size of 5×5. DCT unit 34 may then perform nine DCTs on each of the sub-blocks employing a sub-transform size of 5×5. Alternatively, DCT unit may divide the blocks into twenty-five sub-blocks each comprising a sub-block size of 3×3. DCT unit 34 may then perform twenty-five DCTs on each of the sub-blocks employing a sub-transform size of 3×3. As yet another example, DCT unit may divide the blocks into fifteen sub-blocks each comprising a sub-block size of 5×3. DCT unit 34 may then perform fifteen DCTs on each of the sub-blocks employing a sub-transform size of 5×3.

Filter 36 is coupled to DCT unit 34 and receives the DCT coefficients from DCT unit 34. Filter 36 may be a low pass, high pass, band pass, or any type of filter known in the art. For example, filter 36 may comprise a low pass filter with a certain cut-off frequency, such as for example 10 MHz. In this example, filter 36 may simply zero the values of the DCT coefficients that designate cosine frequencies that are greater than or equal to the specified cut-off frequency, e.g., greater than or equal to 10 MHz. Stated another way, filter 36 may replace the DCT coefficients that designate cosine frequencies that are greater than or equal to the specified cut-off frequency with zero.

In some examples, system 30 includes a quantization unit (not shown) that resides between DCT unit 34 and filter 36. The quantization unit may quantize the DCT coefficients generated by DCT unit 34. For example, if a DCT coefficient is 4.8, the quantizer module may quantize that DCT coefficient to 5. Filter 36 receives the quantized DCT coefficients in examples that include a quantizer module.

IDCT unit 38 is coupled to filter 36, and performs an inverse discrete cosine transform (IDCT) on the filtered DCT coefficients to generate a filtered video sequence. To perform the IDCT, IDCT unit 38 may employ non-dyadic transform sizes. The transform size of IDCT unit 38 may be the same size as the transform size of DCT unit 34. In some examples, system 30 includes a quantization unit (not shown) that resides between filter 36 and IDCT unit 38. The quantization unit may quantize the filtered DCT coefficients, and IDCT unit 38 performs inverse discrete cosine transforms on the quantized filtered DCT coefficients.

Display device 40 is coupled to IDCT unit 38 and receives the filtered video sequence to display the video sequence to a user. Display device 40 may include any of a variety of display devices such as a LCD, plasma display or OLED display. Generally, display unit 40 may be any display capable of displaying video.

FIG. 3 is a block diagram illustrating an example of a video encoder, which may correspond to the video encoder shown in FIG. 1, or may be an encoder in a different device. As shown in FIG. 3, video encoder 20 includes a prediction unit 42, adders 54 and 56, and a reference frame storage element 44. Video encoder 20 also includes a DCT unit 46 and IDCT unit 52. In accordance with the disclosure, DCT unit 46 performs a DCT based on non-dyadic transform sizes. Similarly, IDCT unit 52 performs an inverse DCT based on non-dyadic transform sizes. Video encoder 20 also includes a quantization unit 48, an inverse quantization unit 50, and an entropy coding unit 54.

During the encoding process, video encoder 20 receives a video block to be coded, and prediction unit 42 performs predictive coding techniques. For inter-coding, prediction unit 42 compares the video block to be encoded to various blocks in one or more video reference frames or slices in order to define a predictive block. For intra-coding, prediction unit 42 generates a predictive block based on neighboring data within the same coded unit. Prediction unit 42 outputs the prediction block and adder 54 subtracts the prediction block from the video block being coded in order to generate a residual block.

For inter-coding, prediction unit 42 may comprise motion estimation and motion compensation units that identify a motion vector that points to a prediction block and generates the prediction block based on the motion vector. Typically, motion estimation is considered the process of generating the motion vector, which estimates motion. For example, the motion vector may indicate the displacement of a predictive block within a predictive frame relative to the current block being coded within the current frame. Motion compensation is typically considered the process of fetching or generating the predictive block based on the motion vector determined by motion estimation. For intra coding, prediction unit 42 generates a predictive block based on neighboring data within the same coded unit. One or more intra-prediction modes may define how an intra prediction block can be defined. Consistent with the DCT techniques of this disclosure, the predictive coding techniques may take place with respect to non-dyadic blocks sizes of pixels such as 15×15, 10×10, 5×5, 3×3, 3×5, or 3×2 blocks of pixels. Other non-dyadic blocks sizes described herein with respect to DCT may also be used for blocks sizes of pixels used during predictive coding.

After prediction unit 42 outputs the prediction block and adder 54 subtracts the prediction block from the video block being coded in order to generate a residual block, DCT unit 46 applies a DCT to the residual block. In some aspects, the residual block may be referred to as digital image data. DCT unit 46 applies the transform to the residual block, producing a block of residual transform coefficients. The transform may convert the residual information from a pixel domain to a frequency domain. In accordance with the disclosure, DCT unit 46 applies non-dyadic transform sizes such as 15×15 or 10×10 based on the non-dyadic block size of the residual block. In some aspects, DCT unit 46 may divide the transform size and perform multiple transforms on the residual block. For example, if a residual block comprises a block size of 15×15, DCT unit 46 may subdivide the residual block into nine sub-blocks each comprising a sub-block size of 5×5. DCT unit 46 may then perform nine transforms where the DCT sub-transform size is 5×5 for each of the nine blocks. As another example, again assuming a residual block size of 15×15, DCT unit 46 may subdivide the residual block into twenty-five sub-blocks each comprising a block size of 3×3. DCT unit 46 may then perform twenty-five transforms where the DCT sub-transform size is 3×3 for each of the twenty-five blocks. As yet another example, again assuming a residual block size of 15×15, DCT unit 46 may subdivide the residual block into fifteen sub-blocks each comprising a block size of 3×5 or 5×3. DCT unit 46 may then perform fifteen transforms where the DCT sub-transform size is 3×5 or 5×3 for each of the fifteen blocks. Other permutations may also be possible. For example, assuming a residual bock size of 15×15, DCT unit 46 may subdivide the residual block into five sub-blocks of 3×15 or 15×3, three sub-blocks of 5×15 or 15×5. Furthermore, assuming a residual block size of 10×10, DCT unit 46 may subdivide the residual block into ten sub-blocks of 5×2 or 2×5. DCT unit 46 may then perform ten transforms where the DCT sub-transform size is 5×2 or 2×5 for each of the ten blocks.

DCT unit 46 may subdivide the residual block size based on the video or image quality of the residual block. For example, if the residual block includes image data corresponding to many sharp edges, DCT unit 46 may subdivide a residual block with size 15 to nine residual sub-blocks with size 5, twenty-five residual sub-blocks with size 3, fifteen residual sub-blocks with size 3×5 or 5×3, or five residual sub-blocks with size 5×15 or 15×5.

Quantization unit 48 then quantizes the residual transform coefficients to further reduce bit rate. Quantization unit 48, for example, may limit the number of bits used to code each of the coefficients. Following the quantization process, entropy encoding unit 54 encodes the quantized transform coefficients (along with any syntax elements) according to an entropy coding methodology, such as CAVLC or CABAC, to further compress the data. Syntax elements included in the entropy coded bitstream may include prediction syntax from prediction unit 42, such as motion vectors for inter-coding or prediction modes for intra-coding.

CAVLC is one type of entropy coding technique which may be applied on a vectorized basis by entropy encoding unit 54. CAVLC uses variable length coding (VLC) tables in a manner that effectively compresses serialized “runs” of transform coefficients and/or syntax elements. CABAC is another type of entropy coding technique which may be applied on a vectorized basis by entropy encoding unit 54. CABAC may involve several stages, including binarization, context model selection, and binary arithmetic coding. In this case, entropy encoding unit 54 codes transform coefficients and syntax elements according to CABAC. Many other types of entropy coding techniques also exist, and new entropy coding or new coding techniques will likely emerge in the future. This disclosure is not limited to any specific coding technique.

Following the entropy coding by entropy encoding unit 54, the encoded video may be transmitted to another device or archived for later transmission or retrieval. Again, the encoded video may comprise the entropy coded vectors and various syntax, which can be used by the decoder to properly configure the decoding process. Inverse quantization unit 50 and IDCT 52 apply inverse quantization and inverse DCT, respectively, to reconstruct the residual block in the pixel domain. Summer 56 adds the reconstructed residual block to the prediction block produced by prediction unit 42 to produce a reconstructed video block for storage in reference frame store 44.

FIG. 4 is a block diagram illustrating an example of a video decoder, which may correspond to the video decoder as shown in FIG. 1, or may be a decoder in a different device. The received video sequence may comprise an encoded set of image frames, a set of frame slices, a commonly coded group of pictures (GOPs), or a wide variety of coded video units that include encoded video blocks and syntax to define how to decode such video blocks.

Video decoder 26 includes an entropy decoding unit 58, which performs the reciprocal decoding function of the encoding performed by entropy encoding unit 54 of FIG. 3. In particular, entropy decoding unit 58 may perform CAVLC or CABAC decoding, or any other type of entropy decoding used by video encoder 20. Entropy decoded prediction syntax may be sent from entropy decoding unit 58 to prediction unit 60.

Video decoder 26 also includes a prediction unit 60, an inverse quantization unit 62, an IDCT unit 64, a reference frame store 66, and a summer 68. In accordance with the disclosure, IDCT unit 64 performs an IDCT based on non-dyadic transform sizes such as 15×15 or 10×10. The transform size of IDCT unit 64 may be the same as DCT unit 46 (FIG. 3).

Prediction unit 60 receives prediction syntax (such as motion vectors) from entropy decoding unit 58. Using the prediction syntax, prediction unit 60 generates the prediction blocks that were used to code video blocks. The blocks of data that prediction unit 60 operates with may comprise non-dyadic block sizes of pixels. Inverse quantization unit 62 performs inverse quantization, and IDCT unit 58 performs IDCT to change the coefficients of the residual video blocks back to the pixel domain. In some aspects, the coefficients of the residual video blocks may be referred to a digital image data. As noted above, IDCT unit 58 may employ non-dyadic transform sizes to change the DCT coefficients of the residual video blocks back to the pixel domain. Adder 68 combines each prediction block with the corresponding residual block output by IDCT unit 64 in order to reconstruct the video block. The reconstructed video blocks are accumulated in reference frame store 62 in order to reconstruct decoded frames (or other decodable units) of video information. The decoded units may be output from video decoder 60.

In accordance with the disclosure, a DCT unit such as DCT unit 34 (FIG. 2) or DCT unit 46 (FIG. 3) that employs non-dyadic transform sizes may provide a less complex DCT compared to conventional DCT units that employ only dyadic transform sizes. The complexity of a discrete cosine transform or inverse discrete cosine transform is based on at least the number of multiplications, additions, and shifts that a DCT unit or IDCT unit needs to perform to transform blocks or reconstruct transformed blocks. For example, the complexity of DCT unit 34 or DCT unit 46 is based on the number of multiplications, additions, and shifts each unit needs to perform. As another example, the complexity of IDCT unit 38, IDCT unit 52, or IDCT unit 64 is based on the number of multiplications, additions, and shifts each module needs to perform.

The complexity of a DCT can be calculated in at least two ways. The first technique to compute the complexity of a DCT is derived by splitting multiplication steps that multiply by simple rational factors, e.g., 0.5, 1.5 or 1.25, into additions and shifts, and counting as multiplications only multiplications by irrational constants. The first technique is referred to as complexity metric I. The second technique to compute the complexity of a DCT is derived by counting all multiplications and counting all additions, but requiring no shifting operations. The second technique is referred to as complexity metric II.

A weighted complexity of a DCT or IDCT can be calculated based on the number of multiplications, additions, and shifts the DCT unit or IDCT unit needs to perform. Multiplications may take three cycles of operations, and additions and shifts may only take one cycle of operations. The weighted complexity is calculated by multiplying the number of multiplications by 3 and summing the resulting value with the number of additions and shifts.

Tables 1 and 2 are exemplary lists of the complexity of conventional DCTs of various conventional dyadic transform sizes. The column labeled “N” defines the size of the transform. The column labeled “Complexity Metric I” in table 1 defines the number of multiplications, additions, and shifts that need to be performed. The column labeled “Complexity Metric II” in table 2 defines the number of multiplications and additions that need to be performed. In the “Complexity Metric I” column and “Complexity Metric II” column, the letter “m” defines multiplication, “a” defines addition, and “s” defines shifts. For example, 1m+2a means that only one multiplication is performed and two additions are performed to perform a discrete cosine transform. The column labeled “Weighted Complexity Metric I” in table 1 defines the weighted complexity of the transform based on the Complexity Metric I calculation. The column labeled “Weighted Complexity Metric II” in table 2 defines the weighted complexity of the transform based on the Complexity Metric II calculation. In instances where the DCT requires no multiplications with simple rational numbers, and only multiplications with irrational numbers, the result for the complexity based on metric I and metric II will result in the same value. Accordingly, as can be seen in tables 1 and 2, table 2 only includes two transform sizes (3 and 5) because the result based on Complexity Metric I and Complexity Metric II for the other transform sizes is the same.

TABLE 1

| | Complexity | Weighted Complexity |
|---|---|---|
| N | Metric I | Metric I |
| 2 | 1m + 2a | 5 |
| 3 | 1m + 5a + 1s | 9 |
| 4 | 4m + 9a | 21 |
| 5 | 4m +14a + 1s | 27 |
| 7 | 8m + 30a | 54 |
| 8 | 11m + 29a | 62 |
| 9 | 10m + 34a | 67 |
| 16 | 31m + 81a | 174 |

TABLE 2

| | Complexity | Weighted Complexity |
|---|---|---|
| N | Metric II | Metric II |
| 3 | 2m + 4a | 10 |
| 5 | 5m + 13a | 28 |

In accordance with the disclosure, Tables 3 and 4 are an exemplary list of the complexity of DCTs of various non-conventional non-dyadic transform sizes. Tables 3 and 4 follow the same nomenclature as Tables 1 and 2.

TABLE 3

| | Complexity | Weighted Complexity |
|---|---|---|
| N | Metric I | Metric I |
| 6 | 5m + 18a + 3s | 36 |
| 10 | 13m + 42a + 3s | 84 |
| 11 | 20m + 74a | 134 |
| 12 | 16m + 53a + 7s | 108 |
| 13 | 20m + 82a | 142 |
| 14 | 23m + 80a + 1s | 150 |
| 15 | 14m + 70a + 3s | 115 |

TABLE 4

| | Complexity | Weighted Complexity |
|---|---|---|
| N | Metric II | Metric II |
| 6 | 8m + 16a | 40 |
| 10 | 16m + 40a | 88 |
| 12 | 23m + 49a | 118 |
| 14 | 24m + 80a | 152 |
| 15 | 17m + 67a | 118 |

As can be seen from Tables 1 and 3, a discrete cosine transform with transform size 16 is over 1.5 times more computationally expensive compared to a transform size of 15. The value 1.5 is derived by dividing the weighted complexity for a transform size of 16, i.e., 174, by the weighted complexity for a transform size of 15, i.e., 115. In accordance with the disclosure, as one example, a DCT unit employing a non-dyadic transform size of 15 provides more computational efficient DCTs compared to a DCT unit employing a conventional dyadic transform size of 16.

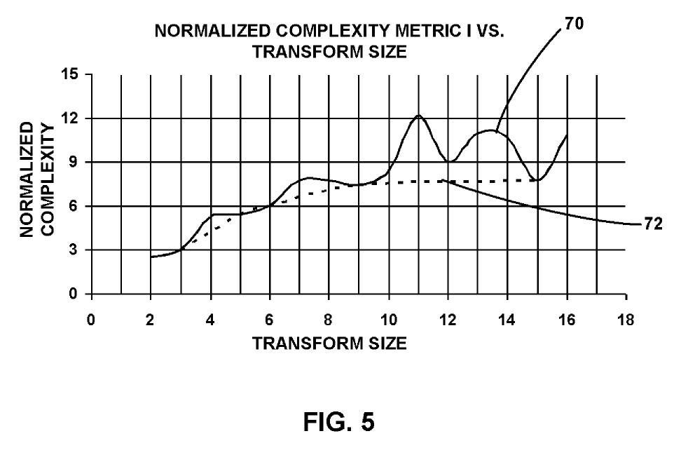

FIG. 5 is a graph illustrating a weighted complexity normalized by a transform size as a function of transform size. The weighted Complexity Metric I is normalized by dividing the weighted complexity value by the transform size. Solid line 70 represents the normalized weighted Complexity Metric I for every transform size of tables 1 and 3. Dashed line 72 represents the normalized weighted Complexity Metric I for certain transform sizes. The transform sizes are 2, 3, 5, 6, 9, and 15. The normalized weighted Complexity Metric I values at transform size 2, 3, 5, 6, 9, and 15 are connected to one another via dashed line 72. As seen in FIG. 5, dashed line 72 provides the lower margin of the complexity. Also as seen in FIG. 5, solid line 70 is considerably above dashed line 72. FIG. 5 illustrates the sub-optimality from a complexity perspective of conventional dyadic transform sizes compared to non-conventional non-dyadic transform sizes. Notably, transform sizes of 15 have much lower complexity than larger transform sizes of 16 and many smaller transform sizes such as 11, 13 and 14.

A computer program simulation was generated to demonstrate the complexity of a DCT at various dyadic and non-dyadic transform sizes. The computer program used two standard images, each at two different resolutions as inputs for the computer program. The first image was a standard image, identified as Kodak's standard image number four. The second image was another standard image, identified as Kodak's standard image number five. The resolutions for Kodak's standard image number four and five were 384×256 and 3072×2048. The image detail for image number four is less than the image detail for image number five.

The computer program simulation (“the program”) first split the image into N×N blocks. The program next performed DCT transforms with N×N transform sizes on each N×N block to produce DCT coefficients. The program quantized the DCT coefficients, and collected statistics of the quantized coefficients. Next the program reconstructed the image via an inverse discrete cosine transform based on the DCT coefficients. The program then measured the average distortions of the reconstructed blocks by comparing the original image to the reconstructed image. Finally, the program estimated the total number of bits needed to encode the image based on the collected statistics of the coefficients.

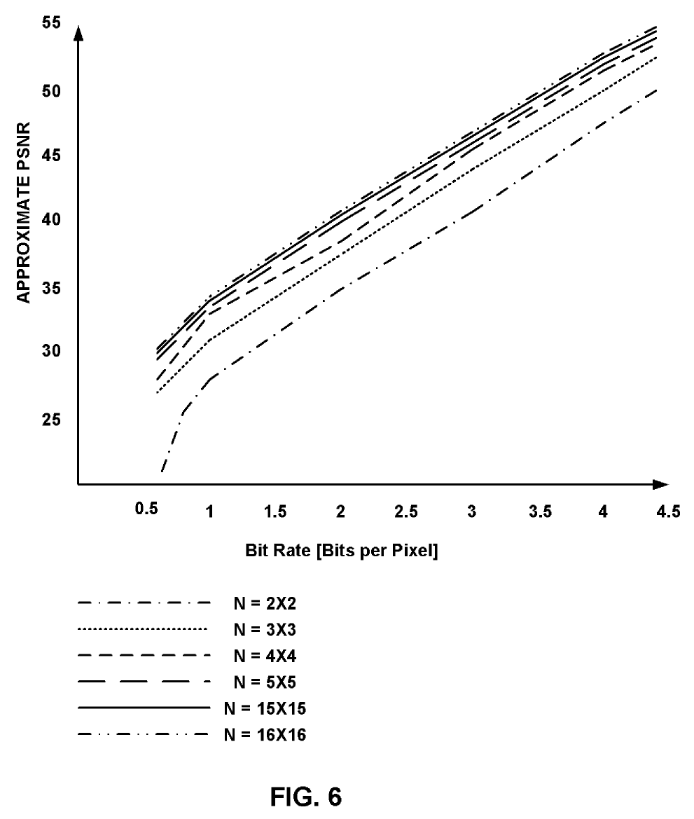

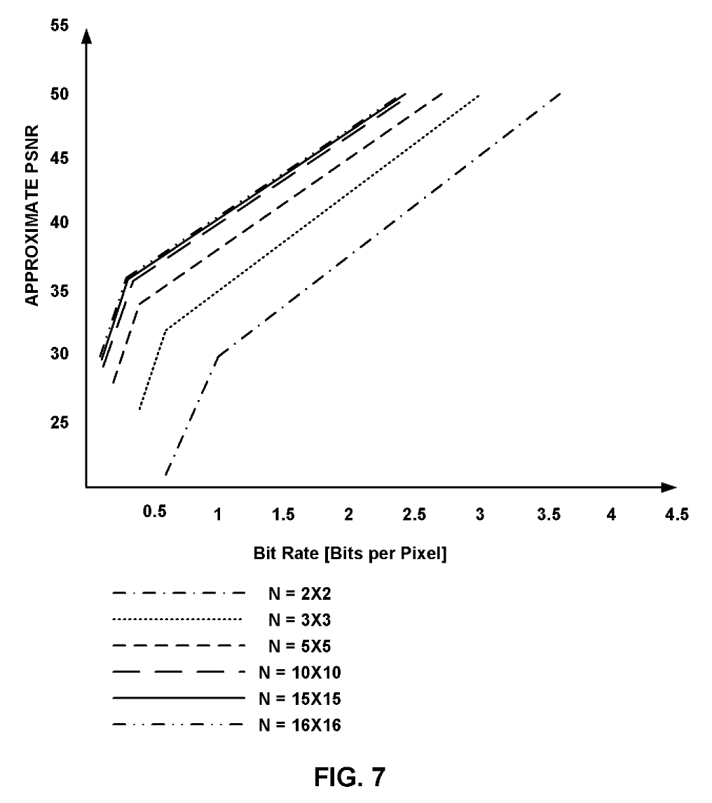

The program output peak signal-to-noise ratio (PSNR) values as a function of bits per pixel for various DCT transform sizes. The PSNR values were calculated by comparing the reconstructed image to the original image and determining the distortion between the reconstructed image and the original image. Example PSNR values are shown in FIGS. 6 and 7. Generally, the higher the PSNR number the better the DCT unit performed in encoding the original image meaning less distortion between the reconstructed image and the original image. The bits per pixel may be referred to as a bit rate and defines the number of digital bits used to represent a pixel value.

FIG. 6 is an example graph illustrating approximate PSNR values for various DCT transform sizes as a function of bit rate for the standard image number four with resolution of 384×256. As shown in FIG. 6, for the standard image number four with resolution of 384×256, the PSNR values generated by the computer program simulation showed a significant difference in performance of transforms of sizes 2, 3, 4, and 5, with larger transforms being better. However, this trend saturated for transform sizes 5 and higher, i.e. all transforms starting from N equals 5 and above showed very similar performance. Larger transforms still performed a bit better, but the additional benefit achieved from N equals 5 to N equals 15 was equivalent to the benefit achieved from N equals 4 to N equals 5. Stated another way, the incremental benefit of a transform of size 15 compared to a transform of size 5 was the same as the incremental benefit of a transform of size 4 compared to a transform of size 5. Since the PSNR values saturated for N equals 5 and higher, instead of performing one DCT with transform size of 15×15 on blocks of size 15×15, it may be beneficial to divide the 15×15 block sizes into nine sub-blocks of size 5×5 and perform nine DCTs with sub-transform size of 5×5.

FIG. 7 is an example graph illustrating approximate PSNR values generated for various DCT transform sizes as a function of bit rate for the standard image number four with resolution of 3072×2048. As shown in FIG. 7, for the standard image number four with resolution of 3072×2048, the PSNR values for different transform sizes followed the same general trend as the PSNR values for the standard image number four with resolution of 384×256. However, due to much higher sampling rate, i.e. 3072×2048 pixels compared to 384×256, the saturation in performance of larger transforms happened at much farther point, e.g. when N equals about 10 compared to N equals 5.

It is important to reiterate that for standard image number four with resolutions of 384×256 and 3072×2048, the PSNR values for a transform of size 16 was substantially similar to the PSNR values for a transform of size 15. Stated another way, a DCT unit employing a transform size of 15 performs substantially similar to a DCT unit employing a transform size of 16. However, as seen in Tables 1 and 3, the complexity of a transform of size 16 is one and half times as complex as a transform of size 15. Accordingly, it may be beneficial for a DCT unit to employ a transform size of 15 instead of a transform size of 16 because a transform size of 15 is one and half times less computationally expensive and provides substantially similar PSNR values as a transform size of 16.

As noted above, Kodak's standard image number five contains much more detail than Kodak's standard image number four. Due to the high-detailed nature of image number five, saturation of DCTs occurred when N equals 3 for a resolution of 384×256. For a resolution of 3072×2048, saturation of DCTs occurred when N equals 7. Since the PSNR values saturated for N equals 5 and higher for a resolution of 384×256, instead of performing one DCT with transform size of 15×15 on blocks of size 15×15, it may be beneficial to divide the 15×15 block sizes into twenty-five sub-blocks of size 3×3 and perform twenty-five DCTs with sub-transform size of 3×3.

As was reiterated for standard image number four, it is important to reiterate that for standard image number five with resolutions of 384×256 and 3072×2048, the PSNR values for a transform of size 16 was substantially similar to the PSNR values for a transform of size 15. Accordingly, it may be beneficial for a DCT unit to employ a transform size of 15 instead of a transform size of 16 because a transform size of 15 is one and half times less computationally expensive and provides substantially similar PSNR values as a transform size of 16.

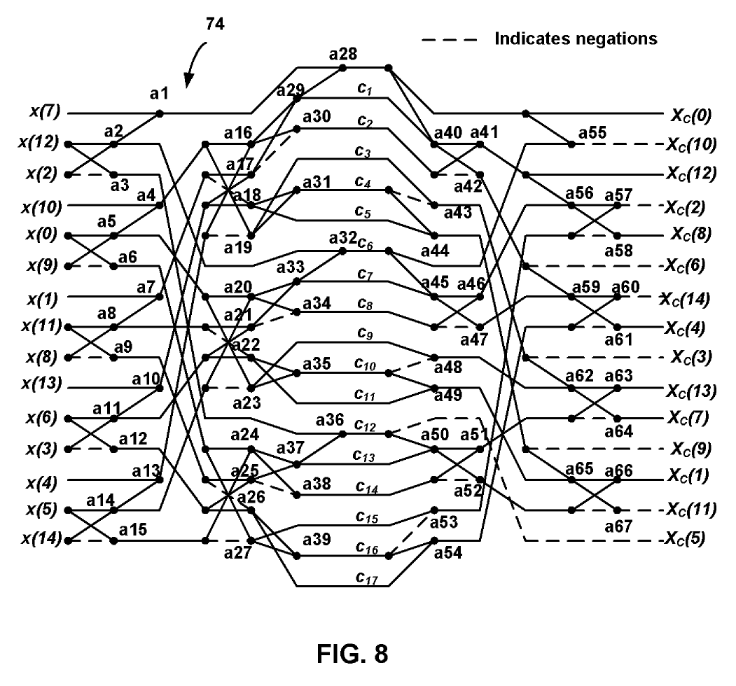

FIG. 8 is a conceptual circuit flow diagram illustrating an exemplary transform 74 with a transform size of 15 that can be used to realized a 2D transform for a block of data that has a 15×15 pixel block size and achieves the complexity metric reported in table 4. Transform 74 may be a DCT or an IDCT. As illustrated in the example of FIG. 6, in examples where transform 74 functions as a DCT, transform 74 takes as input values x(0) through x(14) and generates output values X(0) through X(14). In examples where transform 74 functions as an IDCT, transform 74 takes as input values X(0) through (X14) and generates output values x(1) through x(14). As reported in table 4, the complexity metric II for a transform size of 15 requires 17 multiplications and 67 additions. The multiplication steps are denoted as c₁ through c₁₇, and denote multiplying the variable passing along that point by corresponding constant factors. The values of c₁ through c₁₇ are defined as follows:

$${c}_{1} = \frac{1}{2} [ cos α + cos 2 α ] - 1 ; {c}_{2} = \frac{1}{2} [ cos α - cos 2 α ] ;$$

$${c}_{3} = sin α + sin 2 α ; {c}_{4} = sin 2 α ; {c}_{5} = sin α - sin 2 α ;$$

$${c}_{6} = cos β - 1 ; {c}_{7} = {c}_{1} {c}_{6} ; {c}_{8} = {c}_{2} {c}_{6} ; {c}_{9} = {c}_{3} {c}_{6} ; {c}_{10} = {c}_{4} {c}_{6} ;$$

$${c}_{11} = {c}_{5} {c}_{6} ; {c}_{12} = sin β ; {c}_{13} = {c}_{1} {c}_{12} ; {c}_{14} = {c}_{2} {c}_{12} ; {c}_{15} = - {c}_{3} {c}_{12} ;$$

$${c}_{16} = - {c}_{4} {c}_{12} ; {c}_{17} = - {c}_{5} {c}_{12} ;$$

where

$$α = \frac{- 2 π}{5} ; β = \frac{- 2 π}{3} ; .$$

Notably, factors c₁, c₆, and c₇ are rational numbers with values −5/4, −3/2, and 15/8, respectively. As described above, in some examples, multiplication by a rational number may be easily computed by a series of addition and shift operations. The 67 additions are denoted at nodes a1 through a67. Nodes connecting junctions of pairs of lines denote an addition. For example, node a2 indicates the summation of x(12) and x(2), and node a1 indicates the summation of x(7), x(12), and x(2). The additions can be counted by following the flow of computation (either from left to right for a DCT, or from right to left for an IDCT). The constant factors, e.g., c₁ through c₁₇, are multiplied with intermediate values at corresponding lines in the flow diagram shown in FIG. 8. For example, as seen in FIG. 8, constant factor c₁ is multiplied by the value produced by addition at node a29 and following to the next node. The value at node a29 is the summation of the values at nodes a16 and a17. The value at node a16 is the summation of the values at nodes a4 and a13. The value at node a4 is the summation of x(10) and the value at node a5. The value at node a5 is the summation of x(0) and x(9). The value at node a13 is the summation of x(4) and the value at node a14. The value at node a14 is the summation of x(5) and x(14). The value at node a17 is the summation of the values at nodes a7 and a10. The value at node a7 is the summation of x(1) and the value at node a8. The value at node a8 is the summation of x(11) and x(18). The value at node a10 is the summation of x(13) and the value at node a11. The value at node a11 is the summation of x(6) and x(3). As seen in FIG. 8, the discrete cosine transform structure for a transform size of 15 is well structured. Since the discrete cosine transform structure is so well structured, it may be suitable for parallel or simple instruction, multiple data (SIMD) execution.

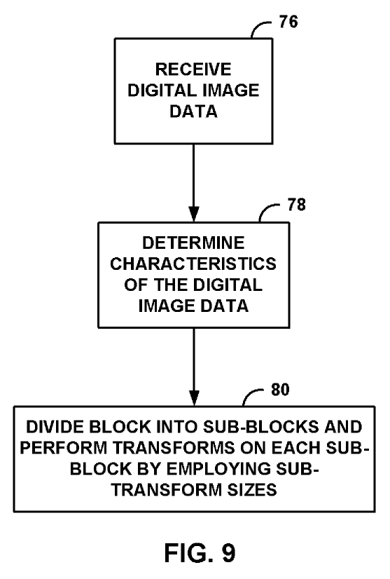

FIG. 9 is a flow diagram illustrating an example technique of dividing a transform size into a plurality of sub-transform sizes. For purposes of illustration, reference will be made to DCT unit 34 of FIG. 2. However, DCT unit 46 (FIG. 3) may perform substantially similar steps. DCT unit 34 receives digital image data (76). Based on the digital image data characteristics, DCT unit 34 determines the transform size (78). Examples of the digital image data characteristics include sharp edges or highly detailed images. It may be beneficial to apply small transform sizes if the digital image data indicates the image includes sharp edges or highly detailed images. In accordance with the disclosure, DCT unit 34 may dynamically divide a block of image data into a plurality of sub-blocks and perform DCT on each of the sub-blocks based on a sub-transform size that is equivalent to the size of each of the sub-blocks to provide a more efficient DCT (80). For example, DCT unit 34 may provide one DCT employing a transform size of 15. Based on the digital image data characteristics, DCT unit 34 may divide the block of image data with size 15×15 into nine sub-blocks each comprising a size of 5×5. DCT unit 34 may then perform nine transforms each comprising a sub-transform size of 5. Alternatively, DCT unit 34 divide the block of image data with size 15×15 into twenty-five sub-blocks each comprising a size of 5×5. DCT unit 34 may then perform twenty-five transforms each comprising a sub-transform size of 3.

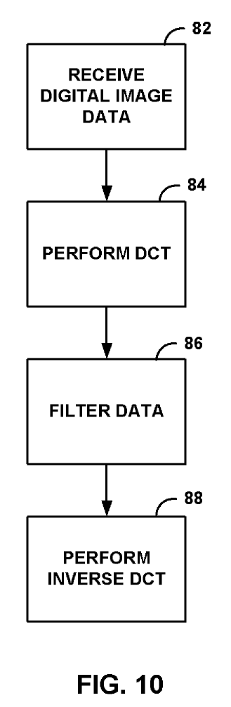

FIG. 10 is a flow diagram illustrating an example technique of filtering digital image data that uses the video filtering system of FIG. 2 of this disclosure. For purposes of illustration, reference will be made to FIG. 2. DCT unit 34 receives digital image data (82). DCT unit 34 performs discrete cosine transform on the received digital image data based on a transform size of at least one of 6, 10, 11, 12, 13, 14, or 15 to generate DCT coefficients (84). Filter 36 filters the DCT coefficients (86). Filter 36 may be a high pass, low pass, or band pass filter, to name a few examples. IDCT unit 36 performs an inverse discrete cosine transform on the filtered DCT coefficients to reconstruct the digital image data (88).

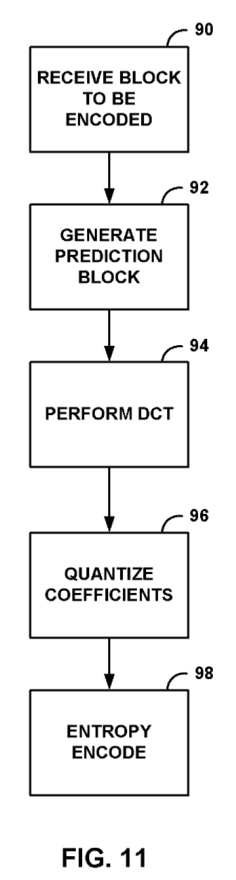

FIG. 11 is a flow diagram illustrating an example technique of encoding digital image data making use of transforms applied to a block of data that has a non-dyadic pixel block size. For purposes of illustration, reference will be made to FIG. 3 where encoder 20 is performing inter-coding. A video block to be encoded is received by prediction unit 42 (90). For inter-coding, prediction unit 42 compares the video block to be encoded to various blocks in one or more video reference frames or slices in order to define a predictive block (92). The video block to be encoded, as well as the various reference blocks may have non-dyadic block sizes, as discussed herein.

DCT unit 46 receives a residual block where the residual block is the prediction block subtracted from the video block that is to be encoded. The residual block may be referred to as digital image data, and may also comprise a non-dyadic block size, as discussed herein. DCT unit 46 performs DCT on the residual image frame based on a transform size of at least one of 6, 10, 11, 12, 13, 14, and 15 to generate DCT coefficients (94). Quantization unit 48 quantizes the DCT coefficients (96). Entropy coding unit 54 entropy codes the quantized DCT coefficients to generate a bitstream that may be subsequently decoded or stored (98).

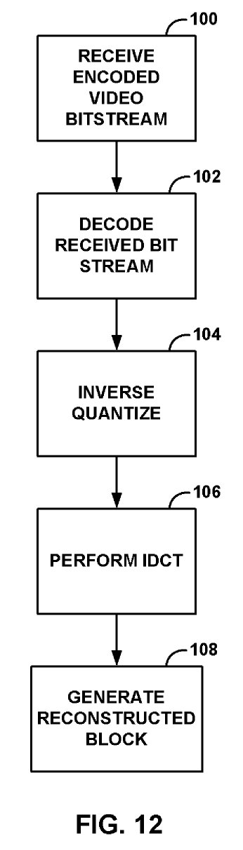

FIG. 12 is a flow diagram illustrating an example technique of decoding digital image data making use of transforms applied to an encoded video bitstream. For purposes of illustration, reference will be made to FIG. 4 where decoder 26 is performing inter-decoding. Entropy decoding unit 58 receives an encoded video bitstream (100). Entropy decoding unit 58 decodes the video bitstream and generates prediction syntax and quantized DCT coefficients (102). Inverse quantization unit 62 inverse quantizes the quantized DCT coefficients (104). IDCT unit 64 performs IDCT on the inverse quantized DCT coefficients based on non-dyadic transform sizes such as 6, 10, 11, 12, 13, 14, and 15 to generate a residual block (106). The inverse quantized DCT coefficients may be referred to a digital image data. Prediction unit 60 receives the prediction syntax from entropy decoding unit 58 and generates the prediction blocks that were used to code video blocks. A reconstructed block is generated by adding the prediction block and the residual block and stored in reference frame store 66 (108).

The techniques described herein may be implemented in hardware, software, firmware, or any combination thereof. Any features described as modules or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more DSPs, general purpose microprocessors, ASICs, field programmable logic arrays FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video encoder-decoder (CODEC). Hence, the disclosure also contemplates any of a variety of integrated circuit devices that include circuitry to implement one or more of the techniques described in this disclosure. Such circuitry may be provided in a single integrated circuit chip or in multiple, interoperable integrated circuit chips.

Various examples have been described. These and other examples are within the scope of the following claims.

1. An apparatus comprising:
a discrete cosine transform (DCT) unit that receives digital image data and generates DCT coefficients, wherein the DCT unit applies a transform size of at least one of 6, 10, 11, 12, 13, 14, and 15.

2. The apparatus of claim 1, wherein the DCT unit applies the transform size of 15.

3. The apparatus of claim 1, wherein applying the transform size comprises:
dividing the transform size into a sub-transform size, wherein the sub-transform size is a multiple of the transform size, wherein the DCT unit applies a plurality of transforms each comprising the sub-transform size.

4. The apparatus of claim 1, wherein applying the transform size of 15 comprises applying nine transforms each comprising a sub-transform size of 5, wherein the DCT unit applies the nine transforms each comprising the sub-transform size of 5 based on the digital image data.

5. The apparatus of claim 1, wherein applying the transform size of 15 comprises applying twenty-five transforms each comprising a sub-transform size of 3, wherein the DCT unit applies the twenty-five transforms each comprising the sub-transform size of 3 based on the digital image data.

6. The apparatus of claim 1, wherein applying the transform size of 15 comprises at least one of:
applying five transforms each comprising a sub-transform size of 3×15, wherein the DCT unit applies the five transforms each comprising the sub-transform size of 3×15,
applying five transforms each comprising a sub-transform size of 15×3, wherein the DCT unit applies the five transforms each comprising the sub-transform size of 15×13,
applying three transforms each comprising a sub-transform size of 5×15, wherein the DCT unit applies the three transforms each comprising the sub-transform size of 5×15,
applying fifteen transforms each comprising a sub-transform size of 3×5, wherein the DCT unit applies the fifteen transforms each comprising the sub-transform size of 3×5, and
applying fifteen transforms each comprising a sub-transform size of 5×3, wherein the DCT unit applies the fifteen transforms each comprising the sub-transform size of 5×3.

7. The apparatus of claim 1 further comprising:
a filter that filters the DCT coefficients; and
an inverse discrete cosine transform (IDCT) unit that receives the filtered DCT coefficients and reconstructs the digital image data.

8. The apparatus of claim 7, wherein applying the transform size of 15 comprises applying nine transforms each comprising a sub-transform size of 5, wherein the DCT unit applies the nine transforms each comprising the sub-transform size of 5 based on the digital image data.

9. The apparatus of claim 7, wherein applying the transform size of 15 comprises applying twenty-five transforms each comprising a sub-transform size of 3, wherein the DCT unit applies the twenty-five transforms each comprising the sub-transform size of 3 based on the digital image data.

10. The apparatus of claim 7, wherein the IDCT unit performs inverse discrete cosine transform based on the transform size of at least one of 6, 10, 11, 12, 13, 14, and 15.

11. The apparatus of claim 1, further comprising:
a prediction unit that receives a block to be encoded and compares the block to be encoded to various blocks in one or more reference frames or slices in order to define a predictive block, wherein the predictive block is subtracted from the block to be encoded to generate a residual block, and wherein the DCT unit receives the residual block as the digital image data to generate the DCT coefficients;
a quantization unit that quantizes the DCT coefficients; and
an entropy coding unit that codes the quantized DCT coefficients and generates a bitstream;

12. The apparatus of claim 11, wherein applying the transform size of 15 comprises applying nine transforms each comprising a sub-transform size of 5, wherein the DCT unit applies the nine transforms each comprising the sub-transform size of 5 based on the digital image data.

13. The apparatus of claim 11, wherein applying the transform size of 15 comprises applying twenty-five transforms each comprising a sub-transform size of 3, wherein the DCT unit applies the twenty-five transforms each comprising the sub-transform size of 3 based on the digital image data.

14. The apparatus of claim 1, further comprising:
a prediction unit that that receives a block to be encoded and generates a predictive block based on neighboring data within the block to be encoded, wherein the predictive block is subtracted from the block to be encoded to generate a residual block, and wherein the DCT unit receives the residual block as the digital image data to generate the DCT coefficients;
a quantization unit that quantizes the DCT coefficients; and
an entropy coding unit that codes the quantized DCT coefficients and generates a bitstream;

15. The apparatus of claim 14, wherein applying the transform size of 15 comprises applying nine transforms each comprising a sub-transform size of 5, wherein the DCT unit applies the nine transforms each comprising the sub-transform size of 5 based on the digital image data.

16. The apparatus of claim 14, wherein applying the transform size of 15 comprises applying twenty-five transforms each comprising a sub-transform size of 3, wherein the DCT unit applies the twenty-five transforms each comprising the sub-transform size of 3 based on the digital image data.

17. The apparatus of claim 1, wherein the apparatus comprises an integrated circuit device.

18. The apparatus of claim 1, wherein the apparatus comprises a device selected from a group consisting of a microprocessor device, a digital camera, a video gaming console, a personal digital assistant (PDA), a portable video player, and a mobile telephone.

19. The apparatus of claim 1, wherein applying the transform size of 15 comprises:
the DCT unit adding 67 values; and
the DCT unit multiplying intermediate values of the 67 values with 17 variables, wherein the 17 variables are denoted as c₁ through c₁₇, wherein:
c₁ equals approximately (cos(−2π/5)+(cos(−4π/5))/2−1,
c₂ equals approximately (cos(−2π/5)−(cos(−4π/5))/2,
c₃ equals approximately sin(−2π/5)+sin(−4π/5),
c₄ equals approximately sin(−4π/5),
c₅ equals approximately sin(−2π/5)−sin(−4π/5),
c₆ equals approximately cos(−2π/3)−1,
c₇ equals approximately c₁*c₆,
c₈ equals approximately c₂*c₆,
c₉ equals approximately c₃*c₆,
c₁₀ equals approximately c₄*c₆,
c₁₁ equals approximately c₅*c₆,
c₁₂ equals approximately sin(−2π/3),
c₁₃ equals approximately c₁*c₁₂,
c₁₄ equals approximately c₂*c₁₂,
c₁₅ equals approximately −c₃*c₁₂,
c₁₆ equals approximately −c₄*c₁₂, and
c₁₇ equals approximately −c₅*c₁₂.

20. A method comprising:
receiving digital image data in a discrete cosine transform (DCT) unit; and
generating DCT coefficients via the DCT unit, wherein the DCT unit applies a transform size of at least one of 6, 10, 11, 12, 13, 14, and 15.

21. The method of claim 20, wherein the DCT unit applies the transform size of 15.

22. The method of claim 20, wherein applying the transform size comprises:
dividing the transform size into a sub-transform size, wherein the sub-transform size is a multiple of the transform size, wherein the DCT unit applies a plurality of transforms each comprising the sub-transform size.

23. The method of claim 20, wherein applying the transform size of 15 comprises applying nine transforms each comprising a sub-transform size of 5, wherein the DCT unit applies the nine transforms each comprising the sub-transform size of 5 based on the digital image data.

24. The method of claim 20, wherein applying the transform size of 15 comprises applying twenty-five transforms each comprising a sub-transform size of 3, wherein the DCT unit applies the twenty-five transforms each comprising the sub-transform size of 3 based on the digital image data.

25. The method of claim 20, wherein applying the transform size of 15 comprises at least one of:
applying five transforms each comprising a sub-transform size of 3×15, wherein the DCT unit applies the five transforms each comprising the sub-transform size of 3×15,
applying five transforms each comprising a sub-transform size of 15×3, wherein the DCT unit applies the five transforms each comprising the sub-transform size of 15×13,
applying three transforms each comprising a sub-transform size of 5×15, wherein the DCT unit applies the three transforms each comprising the sub-transform size of 5×15,
applying fifteen transforms each comprising a sub-transform size of 3×5, wherein the DCT unit applies the fifteen transforms each comprising the sub-transform size of 3×5, and
applying fifteen transforms each comprising a sub-transform size of 5×3, wherein the DCT unit applies the fifteen transforms each comprising the sub-transform size of 5×3.

26. The method of claim 20, further comprising:
filtering the DCT coefficients; and
performing an inverse discrete cosine transform (IDCT) via an IDCT unit that receives the filtered DCT coefficients and reconstructs the digital image data.

27. The method of claim 26, wherein applying the transform size of 15 comprises applying nine transforms each comprising a sub-transform size of 5, wherein the DCT unit applies the nine transforms each comprising the sub-transform size of 5 based on the digital image data.

28. The method of claim 26, wherein applying the transform size of 15 comprises applying twenty-five transforms each comprising a sub-transform size of 3, wherein the DCT unit applies the twenty-five transforms each comprising the sub-transform size of 3 based on the digital image data.

29. The method of claim 26, wherein the IDCT unit applies the transform size of at least one of 6, 10, 11, 12, 13, 14, and 15.

30. The method of claim 20, further comprising:
receiving a block to be encoded via a prediction unit;
comparing the block to be encoded to various blocks in one or more reference frames or slices in order to define a predictive block via the prediction unit, wherein the predictive block is subtracted from the block to be encoded to generate a residual block, and wherein the DCT unit receives the residual block as the digital image data to generate the DCT coefficients;
quantizing the DCT coefficients via a quantization unit; and
coding the quantized DCT coefficients and generating a bitstream via an entropy coding unit;

31. The method of claim 30, wherein applying the transform size of 15 comprises applying nine transforms each comprising a sub-transform size of 5, wherein the DCT unit applies the nine transforms each comprising the sub-transform size of 5 based on the digital image data.

32. The method of claim 30, wherein applying the transform size of 15 comprises applying twenty-five transforms each comprising a sub-transform size of 3, wherein the DCT unit applies the twenty-five transforms each comprising the sub-transform size of 3 based on the digital image data.

33. The method of claim 20, further comprising:
receiving a block to be encoded via a prediction unit;
comparing the block to be encoded to neighboring data within the block to be encoded in order to define a predictive block via the prediction unit, wherein the predictive block is subtracted from the block to be encoded to generate a residual block, and wherein the DCT unit receives the residual block as the digital image data to generate the DCT coefficients;
quantizing the DCT coefficients via a quantization unit; and
coding the quantized DCT coefficients and generating a bitstream via an entropy coding unit.

34. The method of claim 33, wherein applying the transform size of 15 comprises applying nine transforms each comprising a sub-transform size of 5, wherein the DCT unit applies the nine transforms each comprising the sub-transform size of 5 based on the digital image data.

35. The method of claim 33, wherein applying the transform size of 15 comprises applying twenty-five transforms each comprising a sub-transform size of 3, wherein the DCT unit applies the twenty-five transforms each comprising the sub-transform size of 3 based on the digital image data.

36. The method of claim 20, wherein applying the transform size of 15 comprises:
the DCT unit adding 67 values; and
the DCT unit multiplying intermediate values of the 67 values with 17 variables, wherein the 17 variables are denoted as c₁ through c₁₇, wherein:
c₁ equals approximately (cos(−2π/5)+(cos(−4π/5))/2−1,
c₂ equals approximately (cos(−2π/5)−(cos(−4π/5))/2,
c₃ equals approximately sin(−2π/5)+sin(−4π/5),
c₄ equals approximately sin(−4π/5),
c₅ equals approximately sin(−2π/5)−sin(−4π/5),
c₆ equals approximately cos(−2π/3)−1,
c₇ equals approximately c₁*c₆,
c₈ equals approximately c₂*c₆,
c₉ equals approximately c₃*c₆,
c₁₀ equals approximately c₄*c₆,
c₁₁ equals approximately c₅*c₆,
c₁₂ equals approximately sin(−2π/3),
c₁₃ equals approximately c₁*c₁₂,
c₁₄ equals approximately c₂*c₁₂,
c₁₅ equals approximately −c₃*c₁₂,
c₁₆ equals approximately −c₄*c₁₂, and
c₁₇ equals approximately −c₅*c₁₂.

37. A computer readable storage medium comprising instructions that upon execution cause one or more processors to:
receive digital image data; and
generate discrete cosine transform (DCT) coefficients, wherein the instructions cause the one or more processors to apply a transform size of at least one of 6, 10, 11, 12, 13, 14, and 15 to generate the DCT coefficients.

38. The computer readable storage medium of claim 37, wherein the instructions cause the one or more processors to apply the transform size of 15 to generate DCT coefficients.

39. The computer readable storage medium of claim 37, wherein the instructions that cause the one or more processors to apply the transform size of 15 comprises instructions that cause the one or more processors to apply nine transforms each comprising a sub-transform size of 5, wherein the instructions cause the one or more processors to apply the nine transforms each comprising the sub-transform size of 5 based on the digital image data.

40. The computer readable storage medium of claim 37, wherein the instructions that cause the one or more processors to apply the transform size of 15 comprises instructions that cause the one or more processors to apply twenty-five transforms each comprising a sub-transform size of 3, wherein the instructions cause the one or more processors to apply the twenty-five transforms each comprising the sub-transform size of 3 based on the digital image data.

41. An apparatus comprising:
means for receiving digital image data; and
means for generating discrete cosine transform (DCT) coefficients, wherein the means for generating DCT coefficients applies a transform size of at least one of 6, 10, 11, 12, 13, 14, and 15.

42. The apparatus of claim 41, wherein the means for generating DCT coefficients applies the transform size of 15.

43. The apparatus of claim 41, wherein applying the transform size of 15 comprises applying nine transforms each comprising a sub-transform size of 5, wherein the means for generating DCT coefficients applies the nine transforms each comprising the sub-transform size of 5 based on the digital image data.

44. The apparatus of claim 41, wherein applying the transform size of 15 comprises applying twenty-five transforms each comprising a sub-transform size of 3, wherein the means for generating DCT coefficients applies the twenty-five transforms each comprising the sub-transform size of 3 based on the digital image data.

45. A device comprising:
a discrete cosine transform (DCT) unit that receives digital image data and generates DCT coefficients, wherein the DCT unit applies a transform size of at least one of 6, 10, 11, 12, 13, 14, and 15; and
a wireless transmitter that transmits an encoded bitstream that includes the DCT coefficients.

46. The device of claim 45, wherein the device comprises a wireless communication device handset.

47. The device of claim 45, wherein the DCT unit applies the transform size of 15.

48. The device of claim 45, wherein applying the transform size of 15 comprises applying nine transforms each comprising a sub-transform size of 5, wherein the DCT unit applies the nine transforms each comprising the sub-transform size of 5 based on the digital image data.

49. The device of claim 45, wherein applying the transform size of 15 comprises applying twenty-five transforms each comprising a sub-transform size of 3, wherein the DCT unit applies the twenty-five transforms each comprising the sub-transform size of 3 based on the digital image data.

50. A device comprising:
a wireless receiver that receives an encoded bitstream comprising an encoded unit of video data including a plurality of video blocks, discrete cosine transform (DCT) coefficients, and prediction syntax;
an entropy decoding unit that receives the encoded bitstream from the wireless receiver and decodes the bitstream to generate the plurality of video blocks, the DCT coefficients, and the prediction syntax;
an inverse quantization unit that performs inverse quantization on the DCT coefficients;
an inverse discrete cosine transform (IDCT) unit that performs an inverse DCT on the inverse quantized DCT coefficients by employing a transform size of at least one of 6, 10, 11, 12, 13, 14, and 15 to generate a residual block;
a prediction unit that receives the prediction syntax and generates a prediction block;
a summer that sums the residual block and the prediction block to generate a reconstructed block; and
a storage unit that stores the reconstructed block.

51. The device of claim 50, wherein the device comprises a wireless communication device handset.
